(19) United States
(12) Patent Application Publication
(10) Pub. No.: US 2009/0274382 A1
(43) Pub. Date: Nov. 5, 2009

(54) ENTROPY DECODING CIRCUIT, ENTROPY DECODING METHOD, AND ENTROPY DECODING METHOD USING PIPELINE MANNER

(75) Inventors: Chia-Ping Lin, Kaohsiung City (TW); Chao-Tsung Huang, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Novateck Microelectronics Corp., Hsinchu (TW)

(21) Appl. No.: 12/189,814

(22) Filed: Aug. 12, 2008

(30) Foreign Application Priority Data
May 2, 2008 (TW) 97116196

(51) Int. Cl. G06K 9/36

(52) U.S. Cl. 382/238

(57) ABSTRACT

An entropy decoding circuit, an entropy decoding method, and an entropy decoding method using a pipeline manner are provided. The entropy decoding circuit includes a coefficient register unit, a first entropy decoder, a read/write control circuit, and a second entropy decoder. The first entropy decoder reads a first stream to be decoded to perform a first entropy decoding process thereupon and writes it to the coefficient register unit in an adaptive scan order through the read/write control circuit. The second entropy decoder reads a second stream to be decoded and performs a decoding process thereupon according to a normalization parameter and whether a normalized coefficient is zero or not. Meanwhile, the normalized coefficient in the coefficient register unit is read out in a fixed scan order through the read/write control circuit to complete the decoding process.

### CROSS-REFERENCE TO RELATED APPLICATION

This application claims the priority benefit of Taiwan application serial no. 97116196, filed on May 2, 2008. The entirety of the above-mentioned patent application is hereby incorporated by reference herein and made a part of specification.

### BACKGROUND OF THE INVENTION

1. Field of the Invention

The present invention generally relates to a data processing device and an operational method thereof, in particular, to an entropy decoding circuit and a decoding method thereof capable of simultaneously decoding TILE_HIGHPASS and TILE_FLEXBITS.

2. Description of Related Art

In a general image compression encoding process, a downsampling & color space transform is performed mainly in a manner that original image data generates an encoded stream after being transformed and encoding compressed. Afterwards, a lapped transform (LT) is performed. Then, a quantization and a coefficient prediction are performed to generate coded block pattern. Afterwards, an entropy coding is performed by an adaptive scan to generate an encoded stream.

If a compression-encoded stream is to be decoded to the original image data, an inverse decoding process must be performed on the encoding process. The decoding process mainly includes five steps. Referring to FIG. 1, after receiving the encoded stream data, an entropy decoding is performed in Step 110. Afterwards, an inverse coefficient prediction and an inverse quantization are performed in Step 120. Then, an inverse LT is performed in Step 130. Thereafter, an inverse color space transform is performed in Step 140. Take the JPEG standard as an example, first, a variable length decoding is performed on the encoded stream. Then, an inverse coefficient prediction, an inverse quantization, and an inverse discrete cosine transform are performed on a DC term coefficient. Finally, the color space is transformed from the YCbCr color space to a desired color space to complete the image decoding.

A new still image compression format known as the HD Photo format promoted by the Microsoft Corporation (United States) presently has entered the developing process of the JPEG international standard and is designated as the JPEG-XR. The HD Photo format uses an LT in a unit of a 4*4 block in order to reduce the block effect resulted from the independent block transform. First, an overlap filter is performed on 4*4 blocks at intersections of the 4*4 blocks. Then, a core transform is performed on the 4*4 blocks. Both the overlap filter and the core transform use a lifting structure to ensure the possibility of the lossless compression.

FIG. 2 is a schematic view illustrating a flow of an overlap filter transform and a core transform in accordance with the HD Photo format. The content is disclosed in U.S. Patent Application Publication No. 2006/0133682 entitled “Reversible Overlap Operator for Efficient Lossless Data Compression” or U.S. Patent Application Publication No. 2007/0036223 entitled “Efficient Coding and Decoding of Transform Blocks”. They both mention the above HD Photo format. For example, first, 2-dimensional (2-D) input data shown in the figure is tiled. Afterwards, an LT, e.g., a forward overlap filter transform as shown in the figure is performed first to reduce the block effect resulted from the independent block transform, and then a block transform, i.e., an HD Photo core transform (PCT) is performed on the original tiled block, so as to obtain one DC coefficient and fifteen AC coefficients. Moreover, the HD Photo format uses a two-stage transform. Thus, the DC values are aggregated to a block and then the overlap filter and the block transform are performed once again.

The above overlap filter transform and core transform both uses a lifting structure to ensure the possibility of the lossless compression. Every step of the lifting structure is completely reversible. Therefore, if a signal in the field of the lossless compression transform is adopted in the encoding process, a picture exactly identical to the original one may be obtained as long as an inverse core transform is performed first and then an inverse overlap filter transform is performed during the decoding. Whether the first-stage overlap filter transform and the second-stage overlap filter transform are performed or not is selected at will in the HD Photo format. A compressed bitstream may be obtained after performing a quantization and an entropy coding and then a packetization on the obtained DC coefficient and AC coefficients.

The HD Photo specification is quite different from the former JPEG standard in that the HD Photo specification accepts a larger range of pixel values and adopts a customized YCoCg color space and a customized two-stage LT operation and coefficient prediction operation. FIG. 3 mainly illustrates the result of the two-stage transform according to the HD Photo format. Referring to FIG. 3, in the entropy coding part, the coefficients may be divided into different types according to different positions after the transform. For example, the label 310 indicates a macroblock of the result obtained after a first-stage transform, and the label 320 registers all DC values of the result obtained after the first-stage transform. Then, a second-stage transform is performed, the result of which is shown as the LOWPASS block indicated by the label 330. The result of the entire transform is divided into four different types of data, including the DC, LOWPASS, HIGHPASS, and FLEXBITS, according to which the encoding is performed.

As shown in FIG. 3A, a macroblock 310 of coefficients obtained after the transform, quantization, and coefficient prediction includes 16 tiles, each including 4*4 coefficients. These coefficients include one Tile_DC and fifteen AC coefficients. These AC coefficients are coefficients of a Tile_HIGHPASS type and a Tile_FLEXBITS type. All the Tiles_DC are aggregated into the 4*4 block indicated by the label 320 after the first-stage transform. The tilt indicated by the label 330 includes one DC coefficient and other fifteen Tile_LOWPASS marked as LPs in the figure.

A coefficient normalization operation and then an encoding are performed on coefficients in the Tile_DC. First, the encoded block pattern is generated and encoded according to whether the normalized coefficients are zero or not. Then, the normalized coefficients are encoded by using a customized adaptive variable length encoding. Finally, remaining bits of the coefficients due to the normalization are encoded by using a fixed length coding (FLC), and whether the FLC is performed on signs of the coefficients is determined according to whether the coefficients are zero or not.

The encoding of the Tile_LOWPASS is similar to that of the Tile_DC. After the coefficients are normalized, first the encoded block pattern is generated and encoded according to whether all the 15 coefficients in the 4*4 block are zero or not, the normalized coefficients will be transformed to a run-length encoding in an adaptive scan order, and then an adaptive variable length encoding is performed thereupon. Remaining bits of the normalization are encoded by using an FLC in a fixed scan manner. When the non-zero coefficients are zero after the normalization, the FLC will also be performed on signs of the coefficients.

The encoding of the Tile_HIGHPASS and the Tile_FLEXBITS is similar to that of the TILE_LOWPASS. Similarly, the AC coefficients are encoded. Streams in the Tile_HIGHPASS include codes of the coded block pattern and the normalized coefficients, while streams in the Tile_FLEXBITS include fixed length codes on the remaining bits of the normalization and the signs of some coefficients.

The HD Photo format provides two different stream formats. The first stream format is a spatial mode which is the same as the conventional encoding relying mainly on the concatenation of macroblocks. The stream of the Tile_DC and the Tile_LOWPASS, i.e., compressed bitstream, is in the first place of each of the macroblocks. Then, the codes are concatenated in an order of the Tile_HIGHPASS and the Tile_FLEXBITS in each of the blocks in an order of the 4*4 block.

The other stream format is a frequency mode which relies mainly on the concatenation of tiles. Streams of tiles of four different types are concatenated after the tiles are respectively encoded according to the encoding order of the macroblocks. The decoding process of the frequency mode is different from that of the conventional JPEG standard.

Referring to FIG. 3B, the HD Photo decoding flow is shown. First, an entropy decoding is performed on the TILE_DC to obtain DC values of the 4*4 block before the inverse transform of the label 320 in FIG. 3B. Then, the entropy decoding of the TILE_LOWPASS is performed to obtain LP values in the 4*4 block before the inverse transform of the label 330. Then, the decoding of the TILE_HIGHPASS and the TILE_FLEXBITS is performed to obtain AC values of all 4*4 blocks in the macroblock labelled as 310, so as to complete the entropy decoding operation. After the entropy decoding is completed, an inverse coefficient prediction and an inverse quantization and then a first-stage inverse LT are performed on the 4*4 block of the label 320 to obtain the DC values of all the 4*4 blocks in the macroblock labelled as 310. Then, a second-stage inverse LT is performed on the DC values together with the AC values after the inverse coefficient prediction and the inverse quantization. Finally, the color space is transformed from a customized YCoCg color space to a required color space to complete the HD Photo decoding.

The HD Photo entropy decoding is implemented with the hardware, since the coefficients in the AC part are obtained only if the entropy decoding of the TILE_HIGHPASS and the TILE_FLEXBITS is performed. The first half bits of the coefficient, i.e., a normalized coefficient determined according to a normalization parameter, are only obtained by performing the entropy decoding of the TILE_HIGHPASS. The entropy decoding of the TILE_FLEXBITS must be further performed to obtain the second half bits of the coefficient determined according to the normalization parameter, so as to decode the complete coefficient. Therefore, for one coefficient, the entropy decoding must also be performed on the TILE_FLEXBITS in addition to the TILE_HIGHPASS to obtain a complete coefficient, which increases the number of required operational clocks.

### SUMMARY OF THE INVENTION

Accordingly, the present invention is directed to a decoding circuit and a decoding method, capable of simultaneously performing an entropy decoding process of TILE_HIGHPASS and TILE_FLEXBITS for stream bit data in a frequency mode.

The present invention provides an entropy decoding circuit, which includes a coefficient register unit, a first entropy decoder, a read/write control circuit, and a second entropy decoder. The first entropy decoder reads a first stream to be decoded to perform a first entropy decoding process thereupon and writes it to the coefficient register unit in an adaptive scan order through the read/write control circuit. The second entropy decoder reads a second stream to be decoded and performs a decoding process thereupon according to a normalization parameter and whether a normalized coefficient is zero or not. Meanwhile, the normalized coefficient in the coefficient register unit is read out in a fixed scan order through the read/write control circuit to complete the decoding operation.

The present invention provides a decoding circuit, which includes a coefficient register unit, a first entropy decoder, a read/write control circuit, and a second entropy decoder. The coefficient register unit may simultaneously write and read a registered coefficient and store it. The first entropy decoder is used for performing a first entropy decoding process, and generating a normalized coefficient, a decoding order control signal, and a indicating signal which indicates whether the normalized coefficient is zero or not accordingly. The read/write control circuit is connected to the first entropy decoder, for transforming an adaptive scan order to a fixed scan order according to the decoding order control signal output by the first entropy decoder, registering the normalized coefficient according to obtained positions, and adjusting the adaptive scan order according to the indicating signal. The second entropy decoder is connected to a normalized coefficient determination unit and the read/write control circuit, for performing a second entropy decoding process according to a normalization parameter and the information indicating whether the normalized coefficient is zero or not output by the normalized coefficient determination unit, and reading out the normalized coefficient in accordance with the fixed scan order from the read/write control circuit unit, so as to complete the decoding of the coefficient.

The above decoding circuit further includes a normalization parameter generator, which is connected to the first entropy decoder to receive the indicating signal, and take statistics thereupon to calculate the number of all the non-zero normalized coefficients of a block, so as to adjust the normalization parameter and to serve as a basis for adjusting the second entropy decoding process performed by the second decoder.

In the above decoding circuit, the bit stream data is encoded stream bit data in accordance with frequency mode in the HD Photo format. The first entropy decoding process and the second entropy decoding process are a TILE_HIGHPASS entropy decoding process and a TILE_FLEXBITS entropy decoding process respectively.

In the above decoding circuit, the first entropy decoding process and the second entropy decoding process may decode the coefficients in the AC part. An image of customized YCoCg color space in the HD Photo standard is obtained by performing an inverse prediction, an inverse quantization, and a second-stage inverse lapped transform on the coefficients in the AC part together with coefficients decoded by a TILE_DC entropy decoding process and a TILE_LOWPASS entropy decoding process.

The present invention provides an entropy decoding method, which includes the following steps. First and second bit stream data is read and registered in a time-interleaved manner. Then, a first entropy decoding process is performed on the first bit stream data to generate a normalized coefficient, a decoding order control signal, and a indicating signal which indicates whether the normalized coefficient is zero or not. After an adaptive scan order is transformed to a fixed scan order according to the decoding order control signal, the normalized coefficient is registered according to obtained positions, and the adaptive scan order is adjusted according to the indicating signal. The normalized coefficient at a place corresponding to the fixed scan order is read out to perform a second entropy decoding process according to a normalization parameter and whether the normalized coefficient is zero or not.

The above entropy decoding method further includes taking statistics on the indicating signal to calculate the number of all the non-zero normalized coefficients of a block, so as to adjust the normalization parameter and to serve as a basis for adjusting the second entropy decoding process.

In the above decoding circuit, the first entropy decoding process and second entropy decoding process may decode the coefficients in the AC part. An image of the customized YCoCg color space in the HD Photo standard is obtained by performing an inverse prediction, an inverse quantization, and a second-stage inverse LT on the coefficients in the AC part together with the coefficients decoded by a TILE_DC entropy decoding process and a TILE_LOWPASS entropy decoding process.

The present invention provides an entropy decoding method in a pipeline manner, applicable for simultaneously performing a TILE_HIGHPASS entropy decoding process and a TILE_FLEXBITS entropy decoding process on encoded stream bit data in accordance with the frequency mode in an HD Photo format. The method includes the following steps. The encoded stream bit data is read and registered as first and second bit stream data. The first bit stream data is at least one block entropy decoding cycle earlier than the second bit stream data in a time axis. The TILE_HIGHPASS entropy decoding process is performed on the first bit stream data, so as to generate a normalized coefficient, a decoding order control signal, and a indicating signal which indicates whether the normalized coefficient is zero or not. After an adaptive scan order is transformed to a fixed scan order according to the decoding order control signal, the normalized coefficient is registered according to an obtained position, and the adaptive scan order is adjusted according to the indicating signal. The normalized coefficient corresponding to the position of the fixed scan order is read out, and the TILE_FLEXBITS entropy decoding process is performed on the second bit stream data according to a normalization parameter and whether the normalized coefficient is zero or not.

The above entropy decoding method further includes taking statistics on the indicating signal to calculate the number of all the non-zero normalized coefficients of a block, so as to adjust the normalization parameter and to serve as a basis for adjusting the TILE_FLEXBITS entropy decoding process.

In the above entropy decoding method, the TILE_HIGHPASS entropy decoding process and the TILE_FLEXBITS entropy decoding process may decode the coefficients in the AC part. An image of the customized YCoCg color space in the HD Photo standard is obtained by performing an inverse prediction, an inverse quantization, and a second-stage inverse LT on the coefficients in the AC part together with the coefficients decoded by a TILE_DC entropy decoding process and a TILE_LOWPASS entropy decoding process.

In order to the make aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a flow of a decoding operation on a conventional encoded stream.

FIG. 2 is a schematic view illustrating a flow of an overlap filter transform and a core transform in accordance with an HD Photo format.

FIGS. 3A and 3B are schematic views of the result after a two-stage encoding and decoding transform performed according to the HD Photo format.

FIG. 4 is an illustration of an entropy decoding circuit capable of supporting the HD Photo specification according to an embodiment of the present invention.

FIG. 5 is an illustration of a detailed circuit of an entropy decoding architecture supporting the HD Photo specification according to an embodiment of the present invention.

FIG. 6 is a schematic view illustrating a circuit block of an embodiment of a read/write control circuit.

FIG. 7 is a schematic view illustrating a circuit block of another embodiment of the read/write control circuit.

FIG. 8 is a schematic view illustrating a flow of a pipeline processing with one block by a TILE_HIGHPASS and a TILE_FLEXBITS.

FIG. 9 is a schematic view illustrating an updating flow of a normalization parameter in the HD Photo standard.

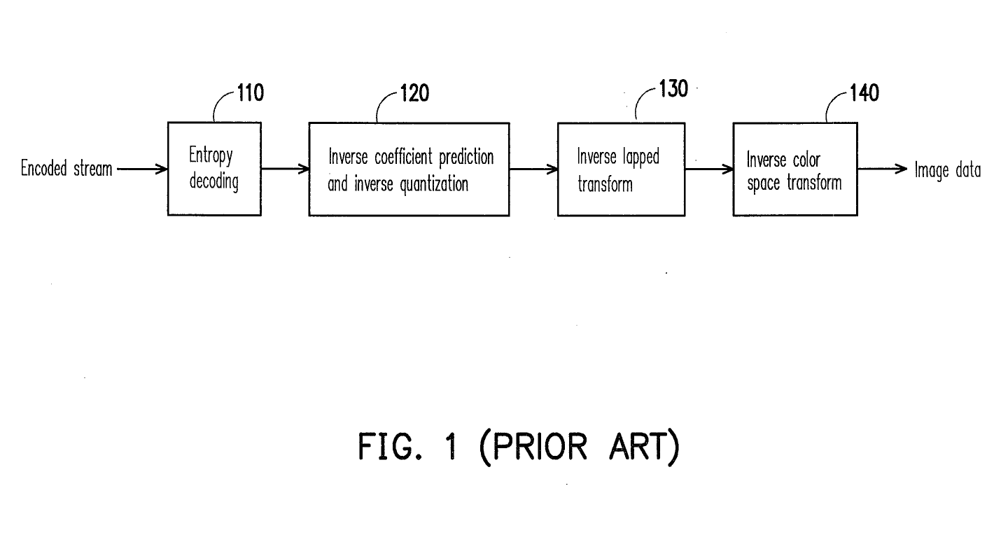

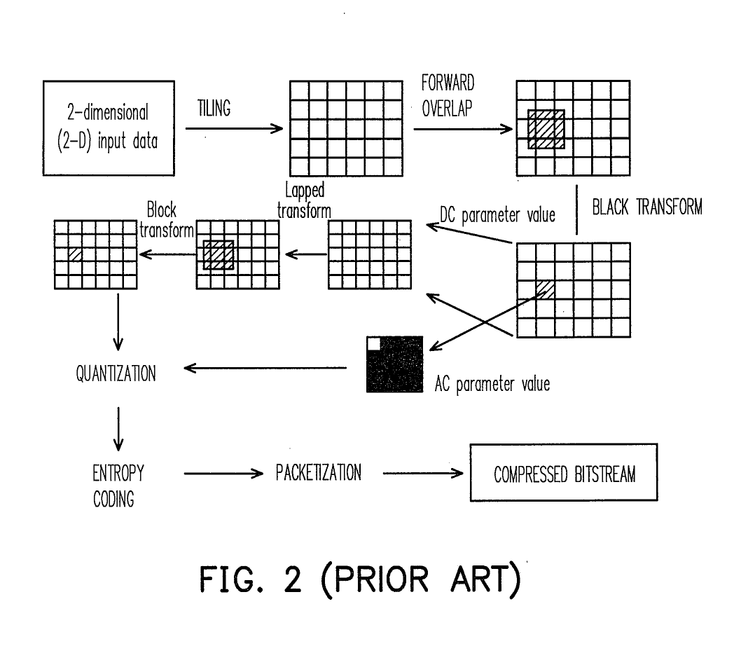

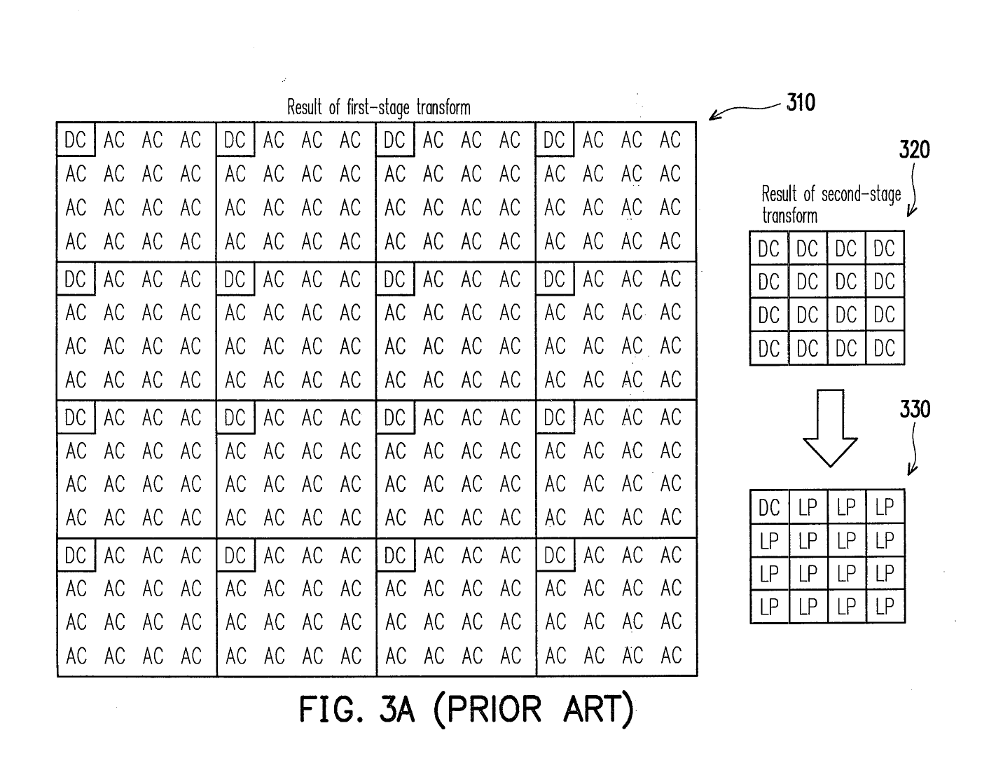

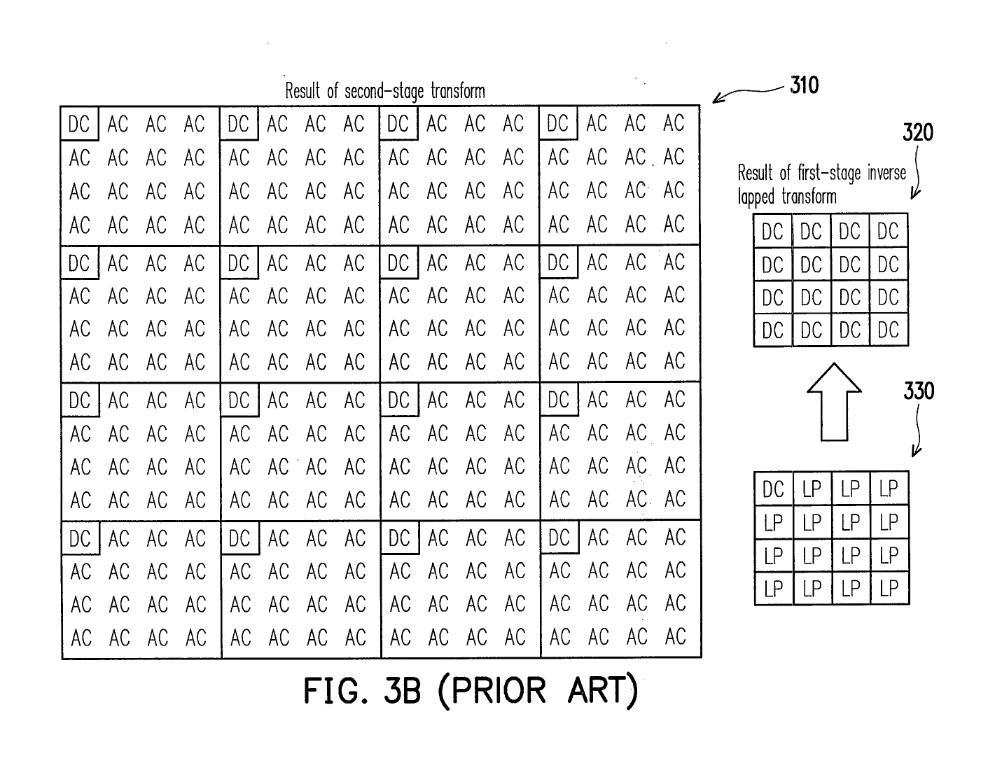

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the present invention, a TILE_HIGHPASS entropy decoding process and a TILE_FLEXBITS entropy decoding process are performed simultaneously for the stream bit data in a frequency mode.

During an encoding processing in the HD Photo format, if the entropy encoding in the HD Photo format is implemented with the hardware, since the HD Photo format performs the normalization operation on one coefficient, as for the coefficient, the encoding must be performed on remaining bits of the normalization in addition to a normalized coefficient. During the operational processes, the Tile_HIGHPASS and the Tile_FLEXBITS are responsible for the encoding of all coefficients in an AC part, which accounts for more than 90% of all coefficients of the entire image and consumes the most clocks in the entropy coding in the HD Photo format by the hardware.

Similarly, when an HD Photo entropy decoding is implemented with the hardware, since the coefficients in the AC part are obtained only if the entropy decoding of the TILE_HIGHPASS and the TILE_FLEXBITS is performed. The first half bits of a coefficient, i.e., a normalized coefficient determined according to a normalization parameter, are only obtained by performing the entropy decoding of the TILE_HIGHPASS. The entropy decoding of the TILE_FLEXBITS must be further performed to obtain the second half bits of the coefficient determined according to the normalization parameter, so as to decode the complete coefficient. Therefore, for one coefficient, the entropy decoding must also be performed on the TILE_FLEXBITS in addition to the TILE_HIGHPASS. Since the coefficients in the AC part account for more than 90% of all coefficients of the entire image, they may be obtained only if the entropy decoding of the TILE_HIGHPASS and the TILE_FLEXBITS is performed, which consumes the most clocks in the HD Photo entropy decoding by the hardware.

The present invention provides a hardware architecture capable of simultaneously decoding the TILE_HIGHPASS and the TILE_FLEXBITS for the entropy decoding process in the HD Photo format, thereby reducing the number of operational clocks required by the hardware decoding.

The TILE_HIGHPASS and the TILE_FLEXBITS decode the same coefficient, with the difference that they have different coefficient scan orders during the decoding and are responsible for different bit segments generated after the normalization. The TILE_HIGHPASS is responsible for a front segment, for example, the most significant bits (MSB) segment of first several bits. The TILE_FLEXBITS is responsible for a back segment, for example, the least significant bits (LSB) segment of last several bits. The result after the normalization is composed of the first bit segment and the last bit segment.

The present invention provides a hardware architecture capable of simultaneously decoding the TILE_HIGHPASS and the TILE_FLEXBITS for the HD Photo entropy decoding when streams to be decoded are concatenated in the frequency mode, thereby reducing the number of operational clocks required by the hardware decoding.

To simultaneously perform the decoding of the TILE_HIGHPASS and the TILE_FLEXBITS, the following problems must be solved.

First, for the entropy decoding of the TILE_FLEXBITS, whether the front segment bits of the coefficient determined according to the normalization parameter are zero or not must be known, so as to determine whether to perform a sign decoding. Therefore, the TILE_FLEXBITS entropy decoding may be performed only if the TILE_HIGHPASS entropy decoding for one coefficient is performed first.

Second, positions of the TILE_HIGHPASS and the TILE_FLEXBITS streams in the encoded stream of the entire image must be known at the same time.

Due to the limitation of the above first problem, the entropy decoding of the TILE_FLEXBITS may be performed only if the entropy decoding of the TILE_HIGHPASS is performed first for one coefficient. However, decoding orders of coefficient positions for the TILE_HIGHPASS and the TILE_FLEXBITS are different. The TILE_HIGHPASS is in an adaptive scan order, while the TILE_FLEXBITS is in a fixed scan order. If they both simultaneously perform the entropy decoding operation according to their decoding orders, the limitation of the first problem will not be ensured to be satisfied, and a decoding failure might occur.

In addition, with regard to the second problem, when the streams to be decoded are concatenated in the frequency mode, the positions of the TILE_HIGHPASS and the TILE_FLEXBITS streams in the encoded stream of the entire image may be known from header parts of the streams. When the streams to be decoded are concatenated in a spatial mode, the positions of the TILE_HIGHPASS and the TILE_FLEXBITS streams in the encoded stream of the entire image are difficult to be known.

Accordingly, in the present invention, the entropy decoding processes of the TILE_HIGHPASS and the TILE_FLEXBITS are performed simultaneously for the stream bit data in the frequency mode.

The present invention provides a coefficient register area. The front segment coefficients decoded by the TILE_HIGHPASS are first written to the register area, and then read out from the coefficient register area after enough front segment coefficients are decoded to perform the entropy decoding of the TILE_FLEXBITS, so as to decode the complete coefficients.

The present invention also provides a read/write controller, which includes an adaptive scan position generator to enable a correct position of the coefficient required by the TILE_FLEXBITS to be known. Therefore, the first problem may be solved by reading out the front segment coefficients at the correct position in the register area. Meanwhile, the TILE_HIGHPASS may continue performing the decoding operation on the front segment coefficients and writing them to the register area, so as to achieve the simultaneous entropy decoding of the two.

A hardware architecture provided in the present invention which is capable of simultaneously performing the entropy decoding process of the TILE_HIGHPASS and the TILE_FLEXBITS for the stream bit data in the frequency mode is illustrated below with particular embodiments.

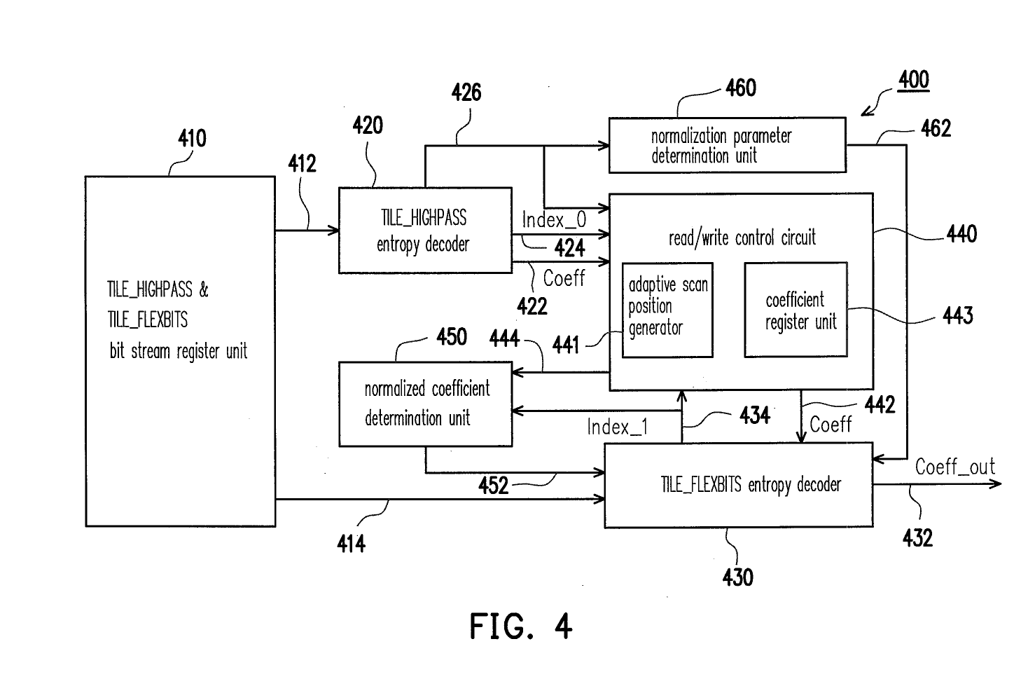

First, referring to FIG. 4, an entropy decoding circuit according to an embodiment of the present invention is the entropy decoding circuit capable of supporting the HD Photo specification. The entropy decoding circuit 400 includes a bit stream register unit 410 which may simultaneously read the bit stream data of the TILE_HIGHPASS and the TILE_FLEXBITS bit stream data and store it. A TILE_HIGHPASS entropy decoder 420 and a TILE_FLEXBITS entropy decoder 430 respectively read the bit stream data through a signal 412 and a signal 414.

Here, the entropy decoding circuit 400 is operated as follows. First, the TILE_HIGHPASS entropy decoder 420 reads a first stream to be decoded and performs a TILE_HIGHPASS entropy decoding process, and writes it to a coefficient register unit 443 in an adaptive scan order through a read and write control circuit (“read/write control circuit”, hereinafter). The TILE_FLEXBITS entropy decoder 430 reads a second stream to be decoded and performs a decoding process according to a normalization parameter and whether a normalized coefficient is zero or not. Meanwhile, the normalized coefficient in the coefficient register unit 443 is read out in a fixed scan order through the read/write control circuit 440, so as to complete the decoding operation. In this embodiment, the coefficient register unit 443 is disposed in the read/write control circuit 440, but it may also be, but not limited to, arranged in any memory capable of reading or writing, which will be described in detail below.

The TILE_HIGHPASS entropy decoder 420 is a decoder capable of performing the TILE_HIGHPASS entropy decoding process. A normalized coefficient 422 (the “Coeff” as shown in the figure) decoded by the TILE_HIGHPASS entropy decoder 420 and a control signal 424 (the “Index_{—}0” as shown in the figure) of a decoding order in the adaptive scan manner are transmitted to the read/write control circuit 440. The information indicating whether the normalized coefficient is zero or not (Normalized_Coeff is zero) is transmitted to a normalization parameter generator 460 and the read/write control circuit 440 through a signal 426.

The read/write control circuit 440 includes an adaptive scan position generator 441 and the coefficient register unit 443. The adaptive scan position generator 441 is a scan position generator in accordance with the HD Photo specification. During the writing, the decoding order in the adaptive scan manner input by the TILE_HIGHPASS entropy decoder 420 is transformed to the fixed scan position and then written to the coefficient register unit 443, and the adaptive scan order is adjusted according to the information indicating whether the normalized coefficient is zero or not obtained by the signal 426. The TILE_FLEXBITS entropy decoder 430 may read the coefficient data Coeff stored in the coefficient register unit 443 through a signal 442, and directly read out the coefficient in accordance with the decoding order position of the fixed scan format data, so as to perform the TILE_FLEXBITS entropy decoding process. In addition, a normalized coefficient determination unit 450 obtains the coefficient data Coeff stored in the coefficient register unit 443 through a signal 444.

Meanwhile, the TILE_FLEXBITS entropy decoder 430 transmits a control signal 434 (Index_1 shown in the figure) to the read/write control circuit 440 as a position for reading the fixed scan order. The TILE_FLEXBITS entropy decoder 430 reads the required coefficient and the information indicating whether the normalized coefficient is zero or not through the read/write control circuit 440. The normalized coefficient is read out and the original coefficient is reconstructed, and the above information indicating whether the normalized coefficient is zero or not is provided by the normalized coefficient determination unit 450 through a signal 452. In the design, the TILE_FLEXBITS entropy decoder 430 may perform the coefficient reconstruction at the same time in the same clock for the decoding, and thus the coefficient needs to be read out. If the operation is a simple decoding, only the normalization parameter and the information indicating whether the normalized coefficient is zero or not need to be known.

The normalization parameter generator 460 is a normalization parameter generator in accordance with the HD Photo standard. The normalization parameter generator 460 receives the information indicating whether the normalized coefficient is zero or not output by the TILE_HIGHPASS entropy decoder 420, takes statistics on the number of non-zero normalized coefficients in one macroblock, adjusts the normalization parameter, and inputs the correct normalization parameter to the TILE_FLEXBITS entropy decoder 430. The TILE_FLEXBITS entropy decoder 430 is a decoder capable of performing the TILE_FLEXBITS entropy decoding, and performs the decoding according to a normalization parameter 462 output by the normalization parameter generator 460. The TILE_FLEXBITS entropy decoding is performed on the stream data output through the signal 414 by the bit stream register unit 410 together with the signal 452, i.e., the information indicating whether the coefficient is zero or not output by the normalized coefficient determination unit 450. The coefficient data Coeff read out by the coefficient register unit 443 is then output through a signal 432 (the Coeff_out shown in the figure) to reconstruct the original coefficient.

The normalization parameter is known as iModelBits in the HD Photo standard, which is a variable name representing a parameter determining a decoding length used in this standard, which is referred to the normalization parameter herein. The iModelBits has six different values depending on different coefficient positions, such as DC, HIGHPASS (HP), LOWPASS (LP), and Y or V. The values thereof may be dynamically adjusted according to the number of the normalized coefficients which are zero at the six different positions in one macroblock (for once after the encoding/decoding of every macroblock). The adjustment manner will be introduced in detail below.

In the above architecture according to the HD Photo encoded stream bit data in the frequency mode, the streams in the TILE_HIGHPASS and the TILE_FLEXBITS parts are input to the entropy decoding circuit 400 to decode the coefficients in the AC part. An image of the customized YCoCg color space in the HD Photo standard is obtained by performing an inverse prediction, an inverse quantization, and a second-stage inverse LT on the coefficients in the AC part together with the coefficients decoded by a TILE_DC and a TILE_LOWPASS. Then, the YCoCg color space is transformed to an appropriate color space, so as to complete the image decoding in accordance with the HD Photo standard.

A memory read circuit may be added in the above architecture, which reads out the TILE_HIGHPASS and the TILE_FLEXBITS streams at correct positions from a memory in a time-interleaved manner according to the header part information of the encoded stream, and writes them to the bit stream register unit 410 for use in the decoding.

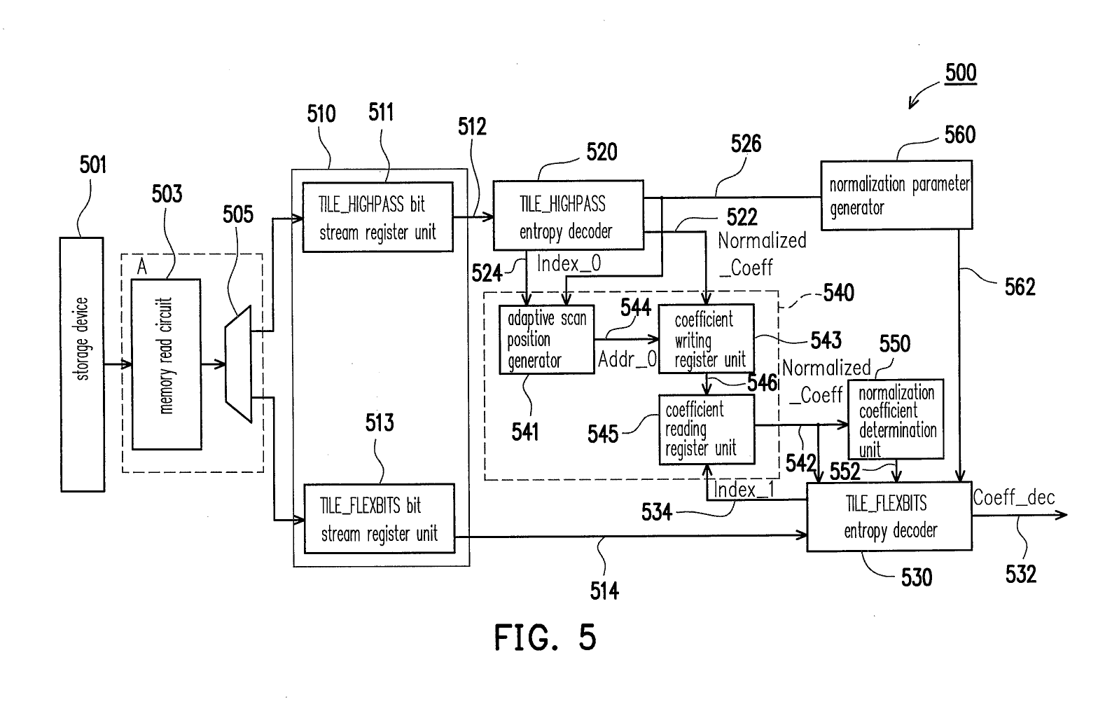

Referring to FIG. 5, a detailed circuit of an entropy decoding architecture supporting the HD Photo specification according to an embodiment of the present invention is shown. The entropy decoding circuit 500 includes a memory read circuit 503 which is connected to a storage device 501. The bit stream data is respectively transmitted to a TILE_HIGHPASS bit stream register unit 511 and a TILE_FLEXBITS bit stream register unit 513 inside a bit stream register unit 510 through a multiplexer 505. In addition, a TILE_HIGHPASS entropy decoder 520 and a TILE_FLEXBITS entropy decoder 530 are respectively connected to the TILE_HIGHPASS bit stream register unit 511 and the TILE_FLEXBITS bit stream register unit 513 through signals 512 and 514, so as to read the bit stream data. A read/write control circuit 540 is connected to the TILE_HIGHPASS entropy decoder 520 and the TILE_FLEXBITS entropy decoder 530. The read/write control circuit 540 includes an adaptive scan position generator 541, a coefficient writing register unit 543, and a coefficient reading register unit 545. In addition, the entropy decoding circuit 500 includes a normalized coefficient determination unit 550 and a normalization parameter generator 560 which are respectively connected to the read/write control circuit 540 and the TILE_HIGHPASS entropy decoder 520.

The entropy decoding circuit 500 is introduced in detail below.

First, the memory read circuit 503 is a read circuit capable of reading the data stored in the memory device 501 in a time-interleave manner. The memory device 501 is, for example, a dynamic random access memory (DRAM). The memory read circuit 503 reads out the TILE_HIGHPASS or the TILE_FLEXBITS stream content in the time-interleaved manner for the bit stream data stored in the memory device 501, and transmits it to the TILE_HIGHPASS bit stream register unit 511 and the TILE_FLEXBITS bit stream register unit 513 respectively through the multiplexer 505 for registering.

The bit stream register unit 510 is a stream buffer area capable of simultaneously reading out two encoded streams, and may be implemented as two static random access memories (SRAMs): one for storing the TILE_HIGHPASS stream, and the other for storing the TILE_FLEXBITS stream, i.e., the TILE_HIGHPASS bit stream register unit 511 and the TILE_FLEXBITS bit stream register unit 513 shown in the figure.

The TILE_HIGHPASS entropy decoder 520 is a decoder capable of performing a TILE_HIGHPASS entropy decoding process. A normalized coefficient 522 (the “Normalized_Coeff” shown in the figure) decoded by the TILE_HIGHPASS entropy decoder 520 is transmitted to the coefficient writing unit 543 of the read/write control circuit 540. A control signal 524 (the “Index_{—}0” shown in the figure) of a decoding order in an adaptive scan manner is transmitted to the adaptive scan position generator 541. In addition, TILE_HIGHPASS entropy decoder 520 further transmits the information indicating whether the normalized coefficient is zero or not (Normalized_Coeff is zero) to the normalization parameter generator 560 and the adaptive scan position generator 541 through a signal 526.

The adaptive scan position generator 541 is a scan position generator in accordance with the HD Photo specification. During the writing, after transforming the decoding (adaptive scan) order input by the TILE_HIGHPASS entropy decoder 520 to a fixed scan position, the normalized coefficient 522 is written to the coefficient writing unit 543 according to the position, and the adaptive scan order is adjusted according to the information indicating whether the normalized coefficient is zero or not obtained by the signal 526. After completing the decoding of one block, the content of the coefficient writing unit 543 will be written to the coefficient reading unit 545 at a time.

Meanwhile, the TILE_FLEXBITS entropy decoder 530 transmits a control signal 534 (the Index_1 shown in the figure) to the coefficient reading register unit 545 in the fixed scan order, with the read normalized coefficient being a signal 542. The TILE_FLEXBITS entropy decoder 530 transmits the decoding order to the coefficient reading unit 545 through the control signal 534, and reads out the normalized coefficient Normalized_Coeff through the signal 542. The coefficients in the coefficient writing register unit 543 and the coefficient reading register unit 545 are coefficients of different blocks with the coefficient written being one block earlier than the coefficient read. After completing the writing, the content of the coefficient writing unit 543 is written to the coefficient reading unit 545 at a time. Afterwards, the coefficient writing unit 543 continues writing the coefficient of a new block, while the content of the coefficient reading unit 545 is transmitted to the TILE_FLEXBITS entropy decoder 530 for reading and no longer changed.

The above architecture uses the coefficient writing unit 543 and the coefficient reading unit 545 for the purpose of forming a coefficient buffer area capable of simultaneously reading and writing. The coefficient writing unit 543 may be implemented as a register for the TILE_HIGHPASS entropy decoder 520 to write the normalized coefficient Normalized_Coeff. When the decoding of one block is completed, the content of the coefficient writing unit 543 is written to the coefficient reading unit 545. The coefficient reading unit 545 may be implemented as a register in combination with a multiplexer, for simultaneously providing the reading of the TILE_FLEXBITS entropy decoder 530.

The normalization parameter generator 560 is a normalization parameter generator in accordance with the HD Photo standard, which receives the information indicating whether the normalized coefficient is zero or not output by the TILE_HIGHPASS entropy decoder 520, takes statistics on the number of non-zero normalized coefficients in one macroblock, adjusts the normalization parameter, and inputs the correct normalization parameter in the TILE_FLEXBITS entropy decoder 530.

The TILE_FLEXBITS entropy decoder 530 is a decoder capable of performing the TILE_FLEXBITS entropy decoding, which performs the decoding according to a normalization parameter 562 output by the normalization parameter generator 560. The TILE_FLEXBITS entropy decoding is performed on the stream data output through the signal 514 by the TILE_FLEXBITS bit stream register unit 513 in combination with the signal 552, i.e., the information indicating whether the coefficient is zero or not output by the normalized coefficient determination unit 550. The normalized coefficient Normalized_Coeff is read out by the coefficient reading unit 545 to reconstruct the original coefficient and output through a signal 532 (the Coeff_dec shown in the figure).

The normalized coefficient determination unit 550 is a circuit capable of generating the information indicating whether the normalized coefficient read out according to the demand of the TILE_FLEXBITS is zero or not. The normalized coefficient determination unit 550 inputs the normalized coefficient Normalized_Coeff read out by the coefficient reading unit 545 and determines whether the coefficient is zero or not with a logic circuit.

An entropy decoding flow of the above entropy decoding circuit 500 according to an embodiment is described as follows. First, a TILE_DC and TILE_LOWPASS entropy decoding is performed on the encoded stream in accordance with the frequency mode of the HD Photo standard to obtain the coefficients in the low frequency part.

Then, the memory read circuit 503 is used to read the TILE_HIGHPASS and TILE_FLEXBITS stream in the memory to the bit stream register units 511 and 513 in the bit stream register unit 510 in the time-interleaved manner first. Then, the TILE_HIGHPASS entropy decoder 520 is used to perform the TILE_HIGHPASS entropy decoding. After decoding a first block, the decoded stream is written at a correct position in the coefficient writing unit 543 through the read/write control circuit 540. Afterwards, the data in the coefficient writing unit 543 is written to the coefficient reading unit 545 at a time.

Afterwards, the TILE_HIGHPASS entropy decoder 520 and the TILE_FLEXBITS entropy decoder 530 may simultaneously perform the entropy decoding operation. When the TILE_HIGHPASS entropy decoder 520 is performing the TILE_HIGHPASS decoding of the next block, the TILE_FLEXBITS entropy decoder 530 may read out the stream data from the inputs of the coefficient reading unit 545, the normalized coefficient determination unit 550, and the normalization parameter generator 560, read out the stream data from the bit stream register unit 513 in the bit stream register unit 510 to perform the decoding operation of the first block at the same time, and finally write out the complete coefficient finally decoded.

An image defined in the YCoCg is obtained through an inverse predication, an inverse quantization, and an inverse transform performed on the coefficients in the AC part decoded in this embodiment and the former coefficients in the low frequency. Then, the color space transform is performed to complete the HD Photo image decoding.

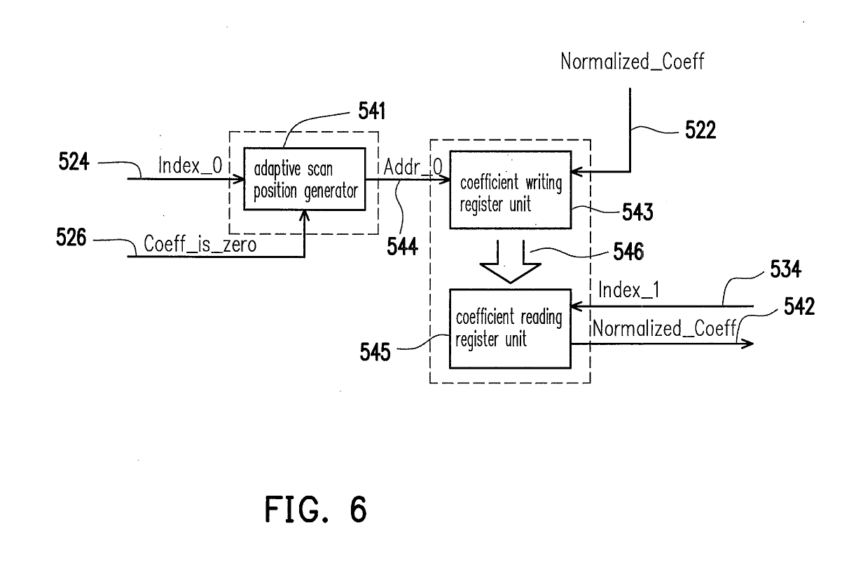

Referring to FIG. 6, a schematic view illustrating a circuit block of an embodiment of the above read/write control circuit 540 is illustrated. In the HD Photo standard, the adaptive scan positions are adjusted according to the encoding (or decoding) order one by one. Upon the encoding (or decoding) of one coefficient, the entire adaptive scan order will be adjusted according to whether the normalized coefficient is zero or not. Therefore, as shown in the figure, the adaptive scan position generator in accordance with the HD Photo standard will need the information indicating whether the normalized coefficient is zero or not.

Therefore, the adaptive scan position generator 541 receives the decoding order control signal 524 and the signal 526 indicating whether the normalized coefficient is zero or not (Normalized_Coeff is zero) to generate a corresponding address signal Addr_0 which is transmitted to the coefficient writing unit 543 through a signal 544. The coefficient writing unit 543 stores the received normalized coefficient 522 (Normalized_Coeff) at a corresponding position according to the address signal Addr_0. Afterwards, after the decoding of one block is completed, the content of the coefficient writing unit 543 is written to the coefficient reading unit 545 at a time through a multiport transmission line 546.

The coefficient is written to the transformed position during the writing in this process. In this way, the decoding order no longer needs to be transformed during the reading. The required coefficient may be read out by treating the decoding order as the position (because the scan order of the TILE_FLEXBITS is fixed which is from left to right and then from top to bottom). The coefficient register area may be implemented as two buffers composed of registers. One buffer may accept the writing and again transmit the content to the second buffer for reading when filled with a certain content.

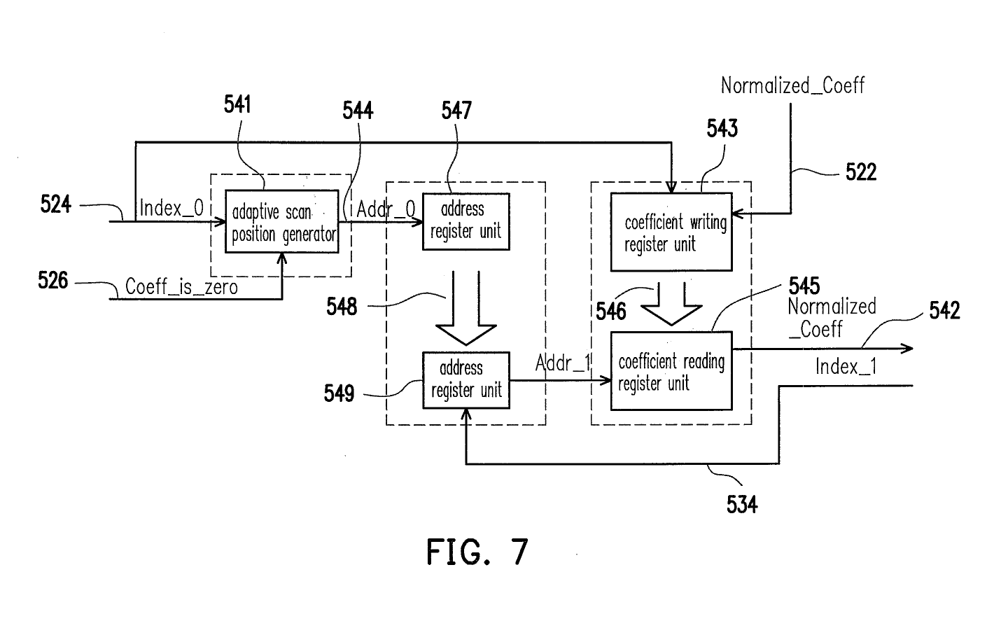

Referring to FIG. 7, a schematic view illustrating a circuit block of another embodiment of the above read/write control circuit 540 is illustrated. This architecture is different from that of FIG. 6 in that the scan order is registered during the writing and then read out by being transformed to the correct read position through comparing the stored scan position during the reading. The two are different in the order, which is illustrated in detail as follows.

The adaptive scan position generator 541 receives the decoding order control signal 524 and the signal 526 indicating whether the normalized coefficient is zero or not (Normalized_Coeff is zero) to generate a corresponding address signal Addr_0 which is transmitted to an address register unit 547 through a signal 544. After the decoding of one block is completed, the corresponding address data of the entire block is transmitted to an address register unit 549 through a multiport transmission line 548. In addition, the coefficient writing unit 543 stores the received normalized coefficient 522 (Normalized_Coeff) at a corresponding position according to the address signal Index_0 (decoding order). Afterwards, after the decoding of one block is completed, the content of the coefficient writing unit 543 is written to the coefficient reading unit 545 at a time through the multiport transmission line 546. During the reading, the TILE_FLEXBITS entropy decoder 530 transmits the control signal 534 (the Index_1 shown in the figure) to the address register unit 549. The registered scan position is compared to be transformed to the correct read position from the address register unit 549 according to the control signal 534. An address signal Addr_1 that is read out is transmitted to the coefficient reading unit 545 to obtain the correct data.

In the HD Photo standard, the adaptive scan positions are adjusted according to the encoding (i.e., decoding) order one by one. Therefore, the adaptive scan positions still must be updated during the TILE_HIGHPASS decoding (because the TILE_FLEXBITS decoding order is different from the TILE_HIGHPASS decoding order). However, the scan order may be registered and not transformed until the reading. Therefore, the writing may be performed based on the decoding order and the scan order is registered. During the reading, the read order is transformed to the correct read position by comparing the registered scan position and then read out. The coefficient register area may be implemented with two buffers composed of registers. One buffer may accept the writing and again transmit the content to the second buffer for reading when filled with a certain content.

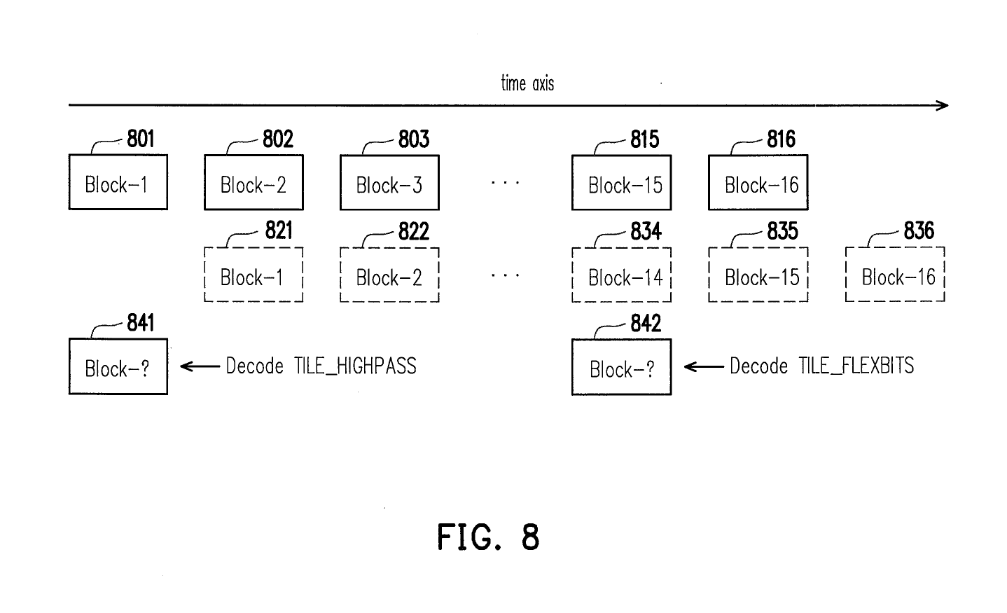

In the above architecture of the entropy decoding circuit 500, since the TILE_FLEXBITS decoding must rely on part of the results decoded by the TILE_HIGHPASS, the orders for performing the entropy decoding of the same block by the two still must have a time difference, thereby forming a pipeline structure. Referring to FIG. 8, a flow of a pipeline processing with one block by the TILE_HIGHPASS and the TILE_FLEXBITS is illustrated. As can been seen clearly, due to the pipeline delay in a time axis, the total number of clocks required by decoding 16 blocks is the time for processing 17 blocks. For example, the 16 blocks 801-816 marked in the figure are used to perform the TILE_HIGHPASS entropy decoding, while the other 16 blocks 821-836 are used to perform the TILE_FLEXBITS entropy decoding. That is, when a block 841 is performing the TILE_HIGHPASS entropy decoding, another block 842 which is one clock cycle delayed in the pipeline is performing the TILE_FLEXBITS entropy decoding. The two processes are simultaneously performed.

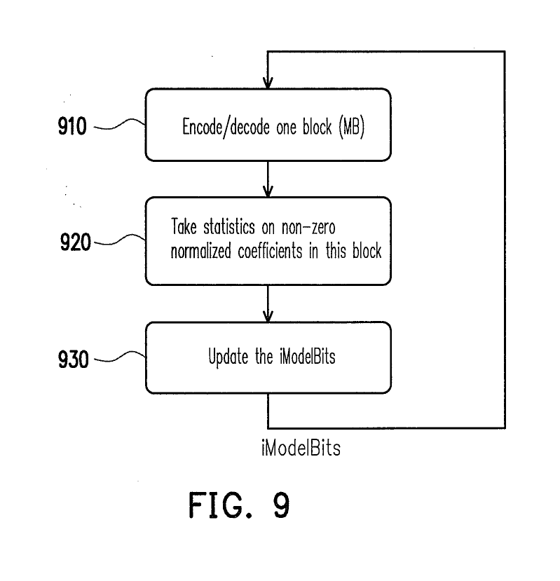

Referring to FIG. 9, a schematic view illustrating an updating flow of a normalization parameter in the HD Photo standard is shown. In the HD Photo standard, the normalization parameter will have six different values depending on different coefficient positions (DC, HP, and LP) and Y or UV. The values thereof may be dynamically adjusted according to the number of the normalized coefficients which are zero at the six different positions in one macroblock (for once after the encoding/decoding of every macroblock). As shown in the figure, after completing an encoding or decoding of one block (MB) (for example, in Step 910), the non-zero normalized coefficients in this block will be calculated through statistics (for example, in Step 920). If the number of the normalized coefficients which are zero is too large, the value of the normalization parameter needs to be increased, such that the normalized coefficients are smaller and the number of the normalized coefficients which are zero is increased to maintain the number at a reasonable value, i.e., updating the value of the iModelBits.

An exemplary example is illustrated. The original normalization parameter used by Y in the HIGHPASS (HP) is assumed to be 0, the fixed length coded (FLC) length in the TILE_FLEXBITS is 0, and the status value (an accumulated variable) thereof is also 0. However, after encoding one macroblock, 240 non-zero normalized coefficients in this part are obtained. After an adjustment, the normalization parameter of Y in the HP of the next macroblock will be changed to 1, and the status value is 0. The basic spirit thereof lies in that, when the number of the normalized coefficients which are zero is too large, the value of the normalization parameter needs to be increased, such that the normalized coefficients are smaller and the number of the normalized coefficients which are zero is increased to maintain the number at a reasonable value. Please refer to the JPEG XR image coding specification for the above-mentioned FLC length in the TILE_FLEXBITS.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An entropy decoding circuit, comprising:
a bit stream register unit, for writing and storing a bit stream and simultaneously reading first and second bit stream data;
a first entropy decoder, for receiving the first bit stream to perform a first entropy decoding process, and generating a normalized coefficient, a decoding order control signal, and an indicating signal which indicates whether the normalized coefficient is zero or not accordingly;
a coefficient register unit, for reading and writing coefficients simultaneously;
a read and write control circuit, connected to the first entropy decoder, for transforming an adaptive scan order into a fixed scan order according to the decoding order control signal output by the first entropy decoder, registering the normalized coefficient in the coefficient register unit according to an obtained position, and adjusting the adaptive scan order according to the indicating signal; and
a second decoder, connected to the read and write control circuit, for receiving the second bit stream and a normalization parameter, reading the coefficient register unit from the read and write control circuit unit to obtain the normalized coefficient, and reading out the normalized coefficient in accordance with the position of the fixed scan order, so as to perform a second entropy decoding process.

2. The entropy decoding circuit according to claim 1, further comprising a normalization parameter generator, connected to the first entropy decoder, for receiving the indicating signal, and take statistics thereupon to calculate the number of all the non-zero normalized coefficients of a block to adjust the normalization parameter and to serve as a basis for adjusting the second entropy decoding process performed by the second decoder.

3. The entropy decoding circuit according to claim 1, wherein the bit stream data is encoded stream bit data in accordance with a frequency domain mode of an HD Photo format.

4. The entropy decoding circuit according to claim 3, wherein the first entropy decoding process and the second entropy decoding process are a TILE_HIGHPASS entropy decoding process and a TILE_FLEXBITS entropy decoding process.

5. The entropy decoding circuit according to claim 4, wherein the first entropy decoding process and the second entropy decoding process are capable of decoding coefficients in an AC part, and an image of a customized YCoCg color space in the HD Photo standard is obtained by performing an inverse prediction, an inverse quantization, and a second-stage inverse lapped transform (LT) on the coefficients in the AC part together with coefficients decoded by a TILE_DC entropy decoding process and a TILE_LOWPASS entropy decoding process.

6. The entropy decoding circuit according to claim 1, further comprising a memory read circuit, for reading out the bit stream data applicable to the first entropy decoding process and the second entropy decoding process from an external memory in a time-interleaved manner according to header part information of the encoded stream.

7. The entropy decoding circuit according to claim 1, wherein the bit stream register unit comprises a first bit stream register unit and a second bit stream register unit, the first bit stream register unit stores the bit stream data applicable to the first entropy decoding process, and the second bit stream register unit stores the bit stream data applicable to the second entropy decoding process.

8. The entropy decoding circuit according to claim 7, further comprising a memory read circuit, for reading out the bit stream data applicable to the first entropy decoding process and the second entropy decoding process from an external memory in a time-interleaved manner according to header part information of the encoded stream, and storing it in the first bit stream register unit and the second bit stream register unit respectively.

9. The entropy decoding circuit according to claim 1, wherein the second entropy decoder transmits a control signal to the read and write control unit to control the coefficient register unit to read out the normalized coefficient.

10. The entropy decoding circuit according to claim 1, wherein the read/write control circuit comprises an adaptive scan position generator, for transforming the adaptive scan order in the fixed scan order according to the decoding order control signal output by the first entropy decoder, registering the normalized coefficient in the coefficient register unit according to the obtained position, and adjusting the adaptive scan order according to the indicating signal.

11. The entropy decoding circuit according to claim 1, wherein the coefficient register unit comprises a coefficient writing unit and a coefficient reading unit, the normalized coefficient is stored at the obtained position of the coefficient writing unit, and content stored in the coefficient writing unit is written in the coefficient reading unit at a time after the decoding of one block is completed.

12. The entropy decoding circuit according to claim 1, wherein the read and write control circuit comprises the adaptive scan position generator, a first address register unit, and a second address register unit, the adaptive scan position generator is used for transforming the adaptive scan order to the fixed scan order according to the decoding order control signal output by the first entropy decoder, registering multiple addresses of multiple obtained positions in the first address register unit, writing the addresses to the second address register unit at a time after the decoding of one block is completed, registering the normalized coefficient in the coefficient register unit according to the decoding order control signal, and controlling read positions according to a decoding order input by the second entropy decoder and the content in the second address register unit.

13. The entropy decoding circuit according to claim 12, wherein the second entropy decoder transmits the control signal to feedback control the second address register unit, so as to obtain the normalized coefficient.

14. The entropy decoding circuit according to claim 1, wherein the first entropy decoding process and second entropy decoding process are performed by a pipeline manner, and the first entropy decoding process is at least one block decoding time earlier than the second entropy decoding process.

15. An entropy decoding method, comprising:
reading and registering first bit stream data and second bit stream data in a time-interleaved manner;
performing a first entropy decoding process on the first bit stream data and generating a normalized coefficient, a decoding order control signal, and an indicating signal which indicates whether the normalized coefficient is zero or not;
transforming an adaptive scan order to a fixed scan order according to the decoding order control signal, registering the normalized coefficient according to an obtained position, and adjusting the adaptive scan order according to the indicating signal; and
reading out the normalized coefficient corresponding to the position of the fixed scan order to perform a second entropy decoding process.

16. The entropy decoding method according to claim 15, further comprising taking statistics on the indicating signal to calculate the number of all the non-zero normalized coefficients of a block, so as to adjust a normalization parameter and to serve as a basis for adjusting the second entropy decoding process.

17. The entropy decoding method according to claim 15, wherein the bit stream data is encoded stream bit data in accordance with a frequency mode in an HD Photo format.

18. The entropy decoding method according to claim 17, wherein the first entropy decoding process and the second entropy decoding process are a TILE_HIGHPASS entropy decoding process and a TILE_FLEXBITS entropy decoding process.

19. The entropy decoding method according to claim 18, wherein the first entropy decoding process and the second entropy decoding process are capable of decoding coefficients in an AC part, and an image of a customized YCoCg color space in the HD Photo standard is obtained by performing an inverse prediction, an inverse quantization, and a second-stage inverse lapped transform on the coefficients in the AC part together with coefficients decoded by a TILE_DC entropy decoding process and a TILE_LOWPASS entropy decoding process.

20. The entropy decoding method according to claim 15, wherein the process of reading the first bit stream data and the second bit stream data in the time-interleaved manner comprises respectively reading out the first bit stream data and the second bit stream data according to header part information of the encoded stream data in the time-interleaved manner.

21. The entropy decoding method according to claim 15, wherein the second entropy decoding process generates a control signal after the decoding, and performs a feedback adjustment to obtain the normalized coefficient.

22. The entropy decoding method according to claim 15, wherein the process of registering the normalized coefficient comprises registering the normalized coefficient at the obtained position of a first register unit and writing the content stored in the first register unit to a second register unit at a time after completing the decoding of one block.

23. The entropy decoding method according to claim 15, wherein after transforming the adaptive scan order to the fixed scan order according to the decoding order control signal, multiple addresses of multiple obtained positions are registered in the first address register unit, the addresses are written to the second address register unit after completing the decoding of one block, and the normalized coefficient is registered in a third register unit according to the decoding order control signal and is output according to the addresses.

24. The entropy decoding method according to claim 15, wherein the first entropy decoding process and the second entropy decoding process are performed by a pipeline manner, the first entropy decoding process is at least one block decoding time earlier than the second entropy decoding process.

25. An entropy decoding method in a pipeline manner, applicable for simultaneously performing a TILE_HIGHPASS entropy decoding process and a TILE_FLEXBITS entropy decoding process on encoded stream bit data in accordance with a frequency mode in an HD Photo format, the method comprising:
reading the encoded stream bit data and registering it as first bit stream data and second bit stream data, wherein the first bit stream data is at least one block entropy decoding cycle earlier than the second bit stream data in a time axis;
performing the TILE_HIGHPASS entropy decoding process on the first bit stream data and generating a normalized coefficient, a decoding order control signal, and an indicating signal which indicates whether the normalized coefficient is zero or not;
transforming an adaptive scan order to a fixed scan order according to the decoding order control signal, registering the normalized coefficient according to an obtained position, and adjusting the adaptive scan order according to the indicating signal; and
reading out the normalized coefficient corresponding to the position of the fixed scan order to perform the TILE_FLEXBITS entropy decoding process on the second bit stream data.

26. The entropy decoding method according to claim 25, further comprising taking statistics on the indicating signal to calculate the number of all the non-zero normalized coefficients of a block, so as to adjust a normalization parameter and to serve as a basis for adjusting the TILE_FLEXBITS entropy decoding process.

27. The entropy decoding method according to claim 25, wherein the TILE_HIGHPASS entropy decoding process and the TILE_FLEXBITS entropy decoding process are capable of decoding coefficients in an AC part, and an image of a customized YCoCg color space in the HD Photo standard is obtained by performing an inverse prediction, an inverse quantization, and a second-stage inverse lapped transform on the coefficients in the AC part together with coefficients decoded by a TILE_DC entropy decoding process and a TILE_LOWPASS entropy decoding process.

28. The entropy decoding method according to claim 25, wherein the encoded stream bit data is respectively read out according to header part information of the encoded stream bit data in the time-interleaved manner.
